(19) United States
(12) Patent Application Publication
(10) Pub. No.: US 2005/0269741 A1
(43) Pub. Date: Dec. 8, 2005

(54) Multi-cavity glass encapsulation method

(75) Inventors: A. John Rigby, Knoxville, TN (US); David M. Folsom, Knoxville, TN (US); Robert Kent Sampson, Maryville, TN (US); Peter Seto, Windsor (CA)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York, NY (US)

(21) Appl. No.: 10/858,871

(22) Filed: Jun. 2, 2004

(51) Int. Cl. B29C 45/14

(52) U.S. Cl. 264/261

(57) ABSTRACT

A fixed pane window assembly is formed in a multicavity encapsulation method. Discrete and independent components are disposed in separate mold cavities. The mold cavities are filled and connected in sequence to form an intermediate body and subsequently an integral fixed pane window assembly incorporating a header trim strip, a division bar, and an incorporated fixed glass pane for cooperatively engaging a moveable window.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to vehicle window assemblies, and more particularly to a method of forming a fixed pane window assembly having a header trim strip, a division bar and an encapsulated pane.

2. Description of Related Art

Many motor vehicles are constructed with a rear door having a forward window opening that carries a retractable, or movable window pane and a rearward window opening that is fitted with a fixed window pane. The fixed window pane, commonly referred to as a quarter light, quarter window or quarter panel, is typically required to avoid interference of the retractable window pane with the rear wheel well of the vehicle, when the retractable window pane is lowered. The larger movable window pane can be completely lowered to a fully open position, while the fixed window pane does not detract from visibility through the windows by the driver or the passengers.

Because the movable window pane slides up and down relative to the adjacent fixed window pane, the molding or trim surrounding the fixed window pane must include a track or channel on a forward edge for slidable engagement with the movable window pane.

Such interconnection requires relatively complicated structures encompassing a number of channels, fasteners and seals as well as secondary clips or fasteners which are employed to engage the components with the vehicle. These numerous parts and labor required to install the individual parts significantly contribute to the cost. In addition, the large number of components represents a source for construction flaws in manufacture as well as installation of the parts.

Therefore, a need exists for a method of forming a fixed window assembly, wherein the resulting assembly includes a least a header trim strip, a division bar and an encapsulated glass. The need further exists for a method which can provide the fixed window assembly with molded materials optimized for the intended operating environment. The need also exists for a multicavity mold which allows for a sequencing of shots to provide for a substantially coincident cure or set time.

### BRIEF SUMMARY OF THE INVENTION

The present invention provides a method of forming a fixed pane window assembly, wherein the individual components are sequentially molded together to provide a one-piece fixed pane window assembly.

In one configuration, a plurality of mold cavities are used to retain individual components of the assembly, wherein the mold cavities are sequentially filled and connected to form the one-piece fixed pane window assembly.

Generally, the present method contemplates disposing at least one of the division bar, the header trim strip and the fixed pane into a first mold cavity and disposing at least one of a remaining one of the division bar, the header trim strip and the pane into a separate second mold cavity. A first polymeric material is then introduced into the first mold cavity to contact the at least one of the division bar, the header trim strip and the pane to form an intermediate body. The first mold cavity is then connected to the second mold cavity, and a second polymeric material is introduced into the second mold cavity to bond the intermediate body to the at least one of the remaining one of the division bar, the header trim strip and the pane. The present invention contemplates employing either similar or different first and second polymeric materials.

It is further contemplated that more than two separate mold cavities can be employed in the present method. For example, each of the header trim strip, the division bar and the fixed pane can be disposed in a corresponding mold cavity. The respective mold cavities can be filled and connected in sequence to provide a resulting one-piece fixed pane window assembly.

### BRIEF DESCRIPTION OF THE SEVERAL VIEWS OF THE DRAWING(S)

FIG. 1 is a perspective view of a motor vehicle incorporating a fixed pane window assembly of the present invention.

FIG. 2 is a side elevational of view of a representative fixed pane window assembly.

FIG. 3 is an exploded side elevational view of the header trim strip, division bar and fixed glass pane of the fixed pane window assembly of FIG. 2.

FIG. 4 is a partial plan view of a plurality of separate mold cavities receiving respective components of the fixed pane window assembly.

### DETAILED DESCRIPTION OF THE INVENTION

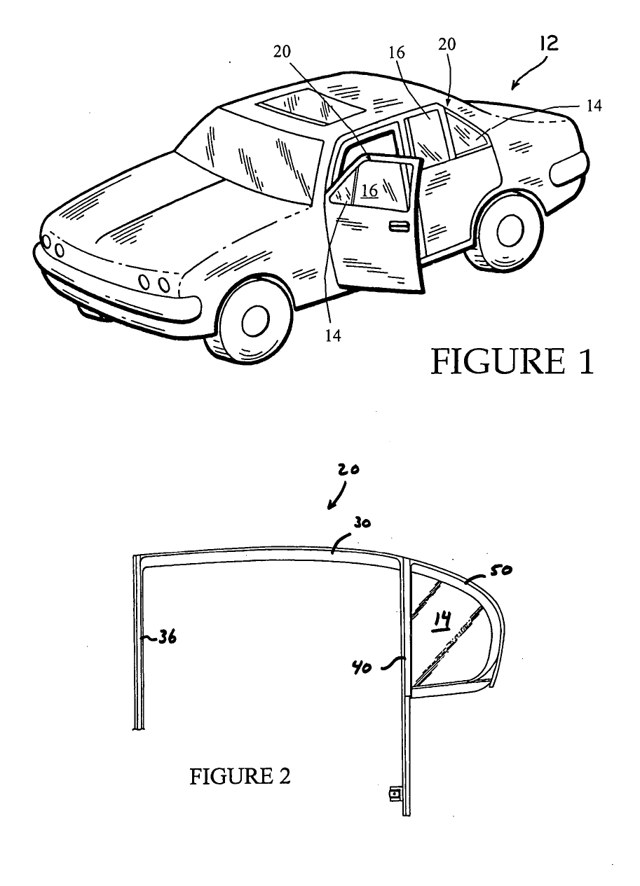

Referring to FIG. 1, an automotive vehicle 12 is shown, incorporating a fixed pane window assembly 20. Although the fixed pane window assembly 20 can be operably employed in a variety of locations in the vehicle, the assembly is suited for providing an interface between a fixed pane 14 and a movable pane 16. As seen in FIG. 1, the fixed pane window assembly 20 can be employed in a front or rear door of the vehicle. Further, the term “fixed pane” is intended to encompass quarter lights, panels or windows that can pivot, swivel or rotate relative to the frame assembly. For example, in one configuration of the assembly, the “fixed pane” can actually pivot to admit air between the pane and the frame. Thus, the fixed pane window assembly 20 encompasses front and rear door installations, wherein the assembly can employ a “fixed pane” which is fixed relative to the frame or pivots, swivels or rotates relative to the frame. For purposes of description, the formation of the fixed pane window assembly 20 is shown as a rear door, operably interconnecting the fixed pane 14 and the movable pane 16.

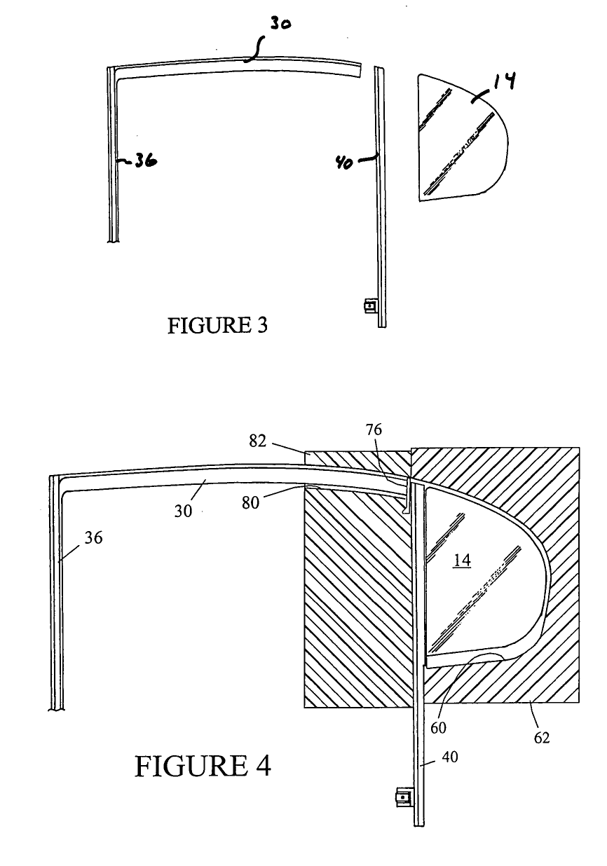

Referring to FIGS. 2 and 3, the fixed pane window assembly 20 includes a header trim strip 30, a division bar 40, and the fixed window pane 14. The fixed window pane 14 is described in terms of a transparent or translucent glass pane. However, it is understood the fixed pane 14 can be an opaque member formed of any of a variety of materials including metals, composites and laminates, each of which is intended to be encompassed by the term pane.

The header trim strip 30 is preformed, typically by an extrusion process. The header trim strip can be operably connected to a B-pillar 36. Such connection to a B-pillar 36 is an optional configuration and not required in the present invention.

The division bar 40 is connected to the fixed pane 14 and the header trim strip 30, and engages a portion of the periphery of the movable pane 16. Although the division bar 40 can have any of a variety of cross-sectional configurations, the division bar typically includes a fixed pane channel for receiving the fixed pane 14 and a movable pane channel for receiving the movable pane 16.

The fixed pane window assembly 20 also includes a glass encapsulation 50 formed of a polymeric material disposed about at least a portion of the periphery of the fixed pane 14. Depending upon the intended connection of the encapsulated fixed pane 14 and the vehicle 12, the glass encapsulation 50 can have any of a variety of configurations, without departing from the present invention.

Although the fixed pane window assembly 20 is shown with only the header trim strip 30, the division bar 40, the fixed pane 14 and the glass encapsulation 50 (with the optional B-pillar 36), it is understood a beltline seal can also be incorporated with the fixed pane window assembly. In an alternative construction, it is contemplated the fixed pane window assembly 20 can include the division bar 40, the fixed pane 14 and the beltline seal, wherein the header trim strip 30 can be subsequently added, connected or attached.

The fixed pane window assembly 20 can include different polymeric materials in different areas so as to provide optimized performance characteristics. That is, in one configuration, the glass encapsulation 50 and bonding of the fixed pane 14 to the division bar 40 can be formed of a relatively hard polymeric material, while the interconnection of the header trim strip 30 and the division bar and fixed pane can be of a softer, more flexible polymeric material.

The interconnection of the header trim strip 30 and the division bar 40 can include a sealing surface for forming a sealed interface with the movable pane 16.

Referring to FIG. 4, a multicavity mold is shown for forming the fixed pane window assembly 20. In the configuration of FIG. 4, a first mold cavity 60 is formed in a first mold block 62, wherein the first mold cavity is sized to receive a portion of the division bar 40 and the fixed pane 14, and a second mold cavity 80 is formed in a second mold block 82, wherein the second mold cavity is sized to receive at least a portion of the header trim strip 30, with the B-pillar seal 36 being optionally connected to the header trim strip. The first mold cavity 60 is separated from the second mold cavity 80 by a movable shuttle or insert 70. The insert 70 is movable between a cavity separating position and a cavity communicating position. Thus, the first mold cavity 60 is defined by a fixed portion and a movable portion (the insert 70). Similarly, the second mold cavity 80 is initially defined by a fixed portion and a movable portion, the insert 70.

As seen in FIG. 4, the insert 70 precludes communication between the first mold cavity 60 and the second mold cavity 80. As the first mold cavity 60 and the second mold cavity 80 are separate, different polymeric materials can be injected into the respective cavities, each polymeric material generally optimized for the intended operating environment. The polymeric material employed in the mold cavities can include a selected polymer resin as well as fillers and additives typically employed in connection with the selected resin. The polymeric materials can be thermoset or thermoplastic, including, but not limited to EPDM, EDPM-SBR blends, polypropylene, polyethylene, polyurethanes, thermoplastic elastomers, thermoplastic vulcanizates, TPOs. Further, it is understood the polymeric material can be formed of only the selected polymeric resin, without additives or fillers.

Preferably, the first mold cavity 60 is sized to encompass an exposed peripheral edge of the fixed pane 14 as well as a portion of the division bar 40. Thus, introduction of a polymeric material encapsulates a periphery of the fixed pane 14, as well as overlying a portion of the division bar 40, thereby bonding the fixed pane to the division bar to form an intermediate body.

The insert 70 is then moved from the cavity separating position to the cavity communicating position. The second mold cavity 80 is then defined by the fixed portion of the second mold cavity and an exposed portion of the intermediate body retained within the first mold cavity 60.

A polymeric material is then introduced into the second mold cavity 80 to bond the header trim strip 30 to the intermediate body. The polymeric material introduced into the second mold cavity 80 can be the same as a polymeric material introduced in the first mold cavity 60. Alternatively, the polymeric materials employed in the first and second mold cavity 60, 80 can be different, each optimized to provide desired operating characteristics of the corresponding portion of the fixed pane window assembly 20.

Employing different polymeric materials in the first and second mold cavity 60, 80 can result in different set or cure times for the respective mold cavity. The set or cure time for a polymeric material in the given mold cavity is partially determined by the volume of the polymeric material within the mold. Typically, the larger the volume of material, the longer the set or cure time. Therefore, it is contemplated to size the first mold cavity 60 and the second mold cavity 80 such that the amount of polymeric material received within the respective mold cavity provides a substantially coincident termination of residence time within the respective cavity.

For example, in the mold shown in FIG. 4, the first mold cavity 60, retaining the fixed pane 14 and the division bar 40, retains a larger volume of polymeric material than the second mold cavity 80 retaining the header trim strip 30. In operation, the first mold cavity 60 is filled first and begins curing/setting. A period of time is allowed for the polymeric material in the first mold cavity 60 to sufficiently set to preclude flow into the second mold cavity 80 upon movement of the insert 70. Further, the intermediate body thus formed in the first mold cavity 60 retains a fixed position within the first mold cavity, during filling of the second mold cavity 80. The insert 70 is moved to the cavity communicating position and the polymeric material introduced into the second mold cavity 80, such that the polymeric material contacts the intermediate body of the first mold cavity. The volume of the polymeric material in the second mold cavity 80, being less than the volume of polymeric material in the first mold cavity 60, has a shorter set or cure time. Preferably, the required residence time of the polymeric material in the second mold cavity 80 is sufficiently shorter than the polymeric material in the first mold cavity 60, such that upon the polymeric material in the first mold cavity being sufficiently stable for opening of the mold, the polymeric material in the second mold cavity is also sufficiently stable for opening of the mold.

However, it is understood the introduction of the first polymeric material, the coupling of the first and second mold cavities and the introduction of the second polymeric material can be a substantially uninterrupted sequence. That is, immediately after introducing the first polymeric material, the mold cavities can be connected and immediately following, the second polymeric material can be introduced into the second mold cavity. Thus, depending upon the selected polymeric materials, the interface between the polymeric materials of the first and second mold cavities can be controlled. Therefore, the sequencing in the present process can be immediate, or delayed wherein the delay between the steps can be on the order or seconds, minutes or hours.

Preferably, the interface between the intermediate body and the polymeric material introduced into the second mold cavity provides a bonded connection. That is, the polymeric material introduced into the second mold cavity bonds to the previously introduced polymeric material in the first mold cavity. It is also preferred the polymeric material of the second mold cavity also bond to any contacted portions of the division bar 40 or the fixed pane 14.

In addition, the timing of the introduction of the polymeric materials is selected to enhance bonding of the polymeric material in the second mold cavity 80 to the intermediate body.

Generally, the present method includes disposing at least one the division bar 40, the header trim strip 30 and the fixed pane 14 into a first mold cavity 60; disposing at least one of a remaining one of the division bar, the header trim strip and the pane into a separate second mold cavity 80; introducing a first polymer resin into the first mold cavity to contact the at least one of the division bar, the header trim strip and the fixed pane to form an intermediate body; interconnecting the first mold cavity and the second mold cavity; and introducing a second polymer resin into the second mold cavity to bond the intermediate body to the at least one of the remaining one of the division bar, the header trim strip and the fixed pane.

Although the method is described in terms of the first mold cavity 60 and the second mold cavity 80, as seen in FIG. 6 it is contemplated that a third mold cavity 100 can be employed wherein each mold cavity retains one of the header trim strip 30, the division bar 40 and the fixed pane 14 of the window assembly 20 and are initially separate and distinct. In such configuration, the molds 60, 80, 100 are selectively interconnected after injecting a polymeric material into the respective mold cavity, thereby forming a first intermediate body and a subsequent second intermediate body. This method can provide for further optimization of the polymeric material for the corresponding portion of the fixed pane window assembly 20.

Therefore, the present method provides a fixed window pane assembly for a motor vehicle, having a one piece molding joining the header trim strip 30, a division bar 40 and a pane 14, the molding encapsulating at least a portion of a periphery of the pane and bonding the division bar with the first polymeric material for defining an intermediate body; and the one piece molding bonding the header trim strip 30 to the intermediate body with a different second polymeric material.

It is further contemplated the volume of the first polymeric material and the volume of the second polymeric material are selected to provide a stable assembly upon a concurrent or simultaneous opening of the first mold cavity and the second mold cavity.

While the invention has been described in connection with a presently preferred embodiment thereof, those skilled in the art will recognize that many modifications and changes can be made without departing from the true spirit and scope of the invention, which accordingly is intended to be defined solely by the appended claims.

1. A method of fabricating a fixed pane window assembly for a motor vehicle, the method comprising:
(a) disposing at least one of a division bar, a header trim strip and a pane into a first mold cavity;
(b) disposing at least one of a remaining one of the division bar, the header trim strip and the pane into a separate second mold cavity;
(c) introducing a first polymeric material into the first mold cavity to contact the at least one of the division bar, the header trim strip and the pane to form an intermediate body;
(d) connecting the first mold cavity to the second mold cavity; and
(e) introducing a second polymeric material into the second mold cavity to bond the intermediate body to the at least one of the remaining one of the division bar, the header trim strip and the pane.

2. The method of claim 1, further comprising disposing a division bar and a pane into the first mold cavity.

3. The method of claim 2, wherein introducing the first polymeric material into the first mold cavity contacts the division bar and the pane to form the intermediate body.

4. The method of claim 1, further comprising disposing a header trim strip into the separate second mold cavity.

5. The method of claim 1, further comprising employing a different second polymeric material than the first polymeric material.

6. The method of claim 1, further comprising employing a common polymeric material as the first polymeric material and the second polymeric material.

7. The method of claim 1, wherein introducing the first polymeric material includes injecting the first polymeric material.

8. The method of claim 1, wherein introducing the second polymeric material includes injecting the second polymeric material.

9. The method of claim 1, further comprising selecting the division bar to have a movable pane channel and a fixed pane channel, the fixed pane channel sized to receive a portion of a periphery of the pane.

10. The method of claim 1, wherein introducing the first polymeric material includes encapsulating at least a portion of a periphery of the pane.

11. The method of claim 1, wherein introducing the first polymeric material bonds the pane to the division bar.

12. The method of claim 1, further comprising selecting a thermoplastic as at least one of the first polymeric material and the second polymeric material.

13. The method of claim 1, further comprising selecting a thermoset as at least one of the first polymeric material and the second polymeric material.

14. The method of claim 1, wherein connecting the first mold cavity to the second mold cavity includes moving an insert from a cavity separating position defining a portion of the first mold cavity to a non-separating position.

15. The method of claim 1, further comprising maintaining a position of the intermediate body relative to the first mold cavity during the connecting of the first mold cavity and the second mold cavity.

16. The method of claim 1, further comprising maintaining the first mold cavity in a closed position during connecting the first mold cavity to the second mold cavity.

17. The method of claim 16, further comprising maintaining the first mold cavity in a closed position during introducing a second polymeric material into the second mold cavity.

18. The method of claim 1, further comprising introducing a larger volume of the first polymeric material than the second polymeric material.

19. The method of claim 1, further comprising introducing a larger volume of the second polymeric material than the first polymeric material.

20. The method of claim 1, further comprising connecting the pane to one of the header trim strip and the division bar for moving the pane relative to the one of the header trim strip and the division bar.

21. The method of claim 1, further comprising fixing the pane relative to the header trim strip and the division bar.

22. The method of claim 1, further comprising connecting one of the division bar and the pane to a beltline seal.

23. The method of claim 1, further comprising connecting the first mold cavity to the second mold cavity immediately after introducing the first polymeric material into the first mold cavity.

24. The method of claim 1, further comprising introducing the second polymeric material into the second mold cavity immediately after connecting the first mold cavity to the second mold cavity.

25. The method of claim 1, further comprising introducing the second polymeric material into the second mold cavity prior to one of setting and curing of the first polymeric material.

26. A fixed pane window assembly for a motor vehicle formed by the method of any one of claims 1-25.
